(19) United States
(12) Patent Application Publication
(10) Pub. No.: US 2018/0289095 A1
(43) Pub. Date: Oct. 11, 2018

(54) HELMET WITH AUDIO FEATURES

(71) Applicant: PECLET LIMITED, Helier, Jersey (GB)

(72) Inventors: Stephen CATTERSON, St. Helier (GB); Dmitry GORILOVSKY, Nurnberg (DE)

(21) Appl. No.: 15/573,972

(22) PCT Filed: May 16, 2016
(86) PCT No.: PCT/GB2016/051410

§ 371 Date: Nov. 14, 2017

(30) Foreign Application Priority Data
May 14, 2015 (GB) 1508284.5
Oct. 16, 2015 (GB) 1518374.2

(51) Int. Cl. A42B 3/30; A42B 3/04; H04B 1/3827; H04W 4/80; H04W 4/10

(52) U.S. Cl. CPC A42B 3/303; A42B 3/306; A42B 3/042; A42B 3/22; H04B 1/385; H04W 4/80; H04W 4/10; A42B 3/0453

(57) ABSTRACT

A helmet configured to provide audio features for the user thereof and a method for the same. The helmet comprises a first communication interface for communications with an audio source. A first audio output is generated based on signal received via the first communication interface. A second communication interface for direct two-way wireless communications with at least one other user on an unlicensed frequency band is also provided, and a second audio output is generated based on signal received via the second communication interface. At least one audio output device is provided for audio output based on signals from the first and second communication interfaces. A user interface enables the user to control the audio features of the helmet. The helmet further comprises control apparatus configured to control the audio features based on user input via the user interface and to provide automated response to at least one predefined event.

### BACKGROUND OF THE INVENTION

### 1. Field of the Invention

This disclosure relates to helmets, and more particularly to a helmet provided with audio features enabling a user thereof to communicate with other users. The helmet is advantageously an action sports helmet.

### 2. Description of the Prior Art

Helmets are used to protect users from head injuries. A particular field where helmets are used is action sports. Non-limiting examples of action sports include mountain biking, climbing, cycling, skateboarding, skiing, snowboarding and so on.

Participants of action sports might wish to be able to communicate with each other. For example, a member of a group may want to comment on the activity, assist or guide others during the activity and/or give warnings and other information to other users during the activity. Such communications can be provided by wireless connections between the participants. If helmets are worn during the activity, speakers and microphones shall be provided such that the participants can hear and be heard while wearing the helmets.

Members of a group can be within sight of each other. However, it is also possible that at least some of the members of the group can be out of sight from the others. For example, participants of a mountain biking or snowboarding session or the like may occasionally depart from each other, even by distances of few kilometres. It is possible to use cellular phones and cellular networks to provide wireless connectivity but action sports may take place in remote terrains and locations where cellular telecommunication networks are not available, or where the reliability and quality of cellular connectivity might not be sufficient.

In addition to reliability the wireless apparatus should not make the helmet more inconvenient to wear and cause unnecessary distraction for a user taking part in a possibly intense activity

It is noted that the above discussed issues are not limited to any particular type and use of helmets.

Embodiments of the invention aim to address one or several of the above issues.

### SUMMARY OF THE INVENTION

In accordance with an aspect there is provided a helmet configured to provide audio features for the user thereof, the helmet comprising a first communication interface for communications with an audio source, wherein a first audio output is generated based on signal received via the first communication interface, a second communication interface for direct two-way wireless communications with at least one other user on an unlicensed frequency band, wherein a second audio output is generated based on signal received via the second communication interface, at least one audio output device for audio output based on signals from the first and second communication interfaces, user interface for enabling the user to control the audio features of the helmet, and control apparatus configured to control the audio features based on user input via the user interface and automated response to at least one predefined event.

In accordance with another aspect there is provided a method for controlling audio features provided for a user by an audio apparatus integrated with a helmet, the helmet comprising control apparatus responsive to user input via a user interface provided on the exterior of the helmet for enabling the user to control the audio features, the method comprising: producing a first audio output based on a signal received from an audio source via a first communication interface of the helmet, determining by the control apparatus communications with at least one other user via a second communication interface for direct two-way wireless communications on an unlicensed frequency band, and performing a control operation by the control apparatus of the helmet on the audio features as an automated response the determining of communications via the second communication interface.

In accordance with a more detailed aspect the first communication interface is for short range wireless radio communications. The short range wireless radio may be configured to operate in accordance with the Bluetooth protocol. The second communication interface can be configured for frequency modulated (FM) communications on ultrahigh frequency (UHF) or very high frequency (VHF) frequency bands.

The user interface can comprise at least one switch on the exterior of the helmet. A plurality of switches can be arranged to smoothly join the shape of the exterior of the helmet. At least one switch can be for controlling the first communication interface and/or the audio source and is located on one side of the helmet. At least one switch can be for controlling the second communication interface and is located on the other side of the helmet. The user interface can comprise a push-to-talk switch.

The predetermined event can comprise determination of at least one of a change in the state of communications via the second communication interface, an incoming call, end of a call, and a public announcement.

The control apparatus can be configured to determine the state of communications on the second communication interface and in response to the determined state apply automatically a control operation on the first audio output. The control operation can comprise, in response to detection of initiation of communications via the second communication interface, cutting off or turning down volume of the first audio output or commanding pausing or stopping playback by the audio source. The control operation can comprise, in response to detection of end of communications via the second communication interface, turning up volume of the first audio output or commanding returning to playback mode of the audio source.

The user interface can be configured to enable the user to perform a control operation on the audio source. The user interface may enable users to input at least one of the following commands: on, off, play, pause, stop, forward, rewind, skip, answer a call, end a call, volume up, volume down, and mute.

Communications via the second communications interface can comprise push-to-talk communications.

Control operation in response to information of communication via the second communication interface can be set to override a command input by the user via the user interface.

A frequency band can be automatically selected based on information of the location of the helmet. Selection of the frequency band can be based on information from a satellite based positioning system and/or a cellular network based positioning system.

The helmet may comprise an action sports helmet.

The helmet may comprise a sub-assembly module including control electronics. The sub-assembly joins smoothly the overall shape of the helmet.

A communication system comprising at least two helmets as described herein and associated at least two audio sources may also be provided.

Other aspects include:

A helmet that includes one or more removable panels, such as a visor or peak panel at the front of the helmet, a top ventilation panel and a strap holder panel at the back of the helmet.

A helmet that is configured to operate as a portable loudspeaker when not being worn and to provide headphone functionality when being worn.

A helmet including communications circuitry and antenna in a detachable module that can attach to the helmet.

A sports helmet that handles data that defines its location and can automatically generate location specific spoken messages played through helmet speakers

### BRIEF DESCRIPTION OF THE DRAWINGS

Various exemplifying embodiments of the invention are illustrated by the attached drawings. Steps and elements may be reordered, omitted, and combined to form new embodiments, and any step indicated as performed may be caused to be performed by another device or module. In the Figures:

FIG. 1 illustrates an example of a helmet in accordance with the invention;

FIG. 2 shows the helmet of FIG. 1 such that certain internal components thereof are visible;

FIG. 3 shows a flowchart in accordance with an example of operation;

FIG. 4 shows communications in a group of users;

FIG. 5 shows a further embodiment of a helmet;

FIG. 6 shows data processing apparatus; and

FIG. 7-11 show an implementation of the helmet with detachable panels.

### DETAILED DESCRIPTION

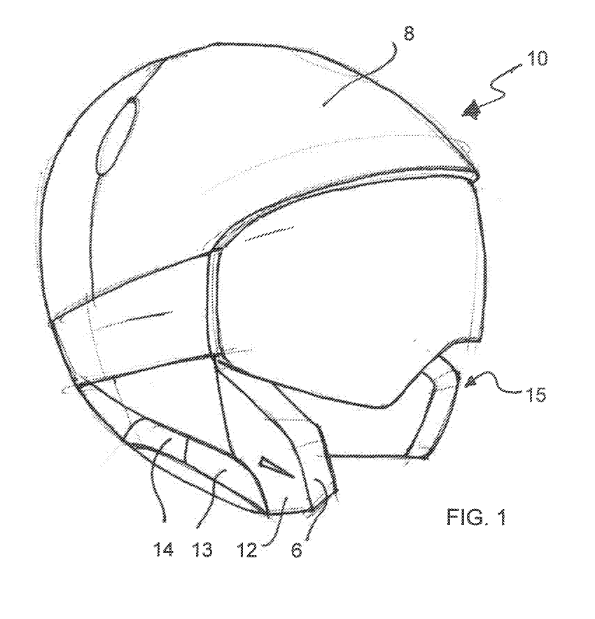

FIG. 1 shows an example of a helmet 10 configured in accordance with the current invention. The helmet can be an action sports helmet used in sports such as cycling, mountain biking, climbing, skateboarding, downhill skiing, snowboarding and so forth. A helmet typically comprises a hard outer shell 8 and an impact absorbent liner within the outer shell. Padding is also provided to make the helmet more comfortable to wear. A helmet can also have at the lower portion thereof a forward protruding element to protect the lower parts of a face of the user, the front of the helmet 10 being formed to provide a chin guard 6. FIG. 1 example shows a so-called open face helmet where there is a cap in the chin guard 6, but other designs are also possible. For example, a chin guard can extend continuously from one side to the other. Certain types of helmets have no chin guards.

A group of participants in action sports, wearing helmets, might wish to communicate with each other. The communications are provided with a wireless two-way communication system that is not reliant on a cellular network but can still provide a sufficient range for communications even with out-of-sight users. An appropriate wireless radio unit is integrated with the helmet, examples of which will be explained in more detail below. At the same time, a user of a helmet may want to listen to music or other audio presentation. However, this can mean that there are occasionally two simultaneous audio presentations. This can be disturbing and in certain instances even dangerous. For example, if a warning is sounded via the wireless communication system to a user listening to loud music, he may miss that altogether, or at least not understand the warning message. Further, a user participating in action sports should concentrate on the activity, and use and control of the audio features should require as little attention and cause as little distraction as possible.

In accordance with the herein described examples, the helmet 10 can comprise a first communication interface for communications with an audio source via a short range link. The first interface can comprise a short range radio unit in accordance with an appropriate short range radio communications protocol. The first communication interface can comprise, for example, a short range wireless radio configured to operate in accordance with the Bluetooth™ protocol.

A second communication interface for direct two-way wireless communications with other users in the group is also provided. The second communication interface operates on an unlicensed frequency band. The second communication interface can comprise a radio unit configured for FM (frequency modulated) communications, for example on 400-480 MHz UHF (ultra high frequency) band where unlicensed two-radio is permitted in the majority of territories around the world. Unlicensed radio applications can also be permitted in the VHF (very high frequency) bands, and thus VHF capable radio can also be used for this purpose.

The helmet further comprises audio output apparatus. This can comprise, for example, left and right earpieces, or a headset integrated with the padding of the helmet. The audio output apparatus generates audio output based on signals from the first and second communication interfaces. A microphone apparatus is also provided to enable the user to at least talk to the other users.

The audio source may comprise a music or other media player, for example an mp3 player, a mobile phone, a smart phone, a tablet computer, a notebook, a laptop computer, an electronic book, a voice recorder or like device, capable of causing an audio presentation for the user via suitable audio output elements integrated with the helmet. The audio source can be an external device placed in a pocket of the user or secured on his/her body by suitable straps or the like.

The user can control the audio features of the helmet through an interface integrated with the helmet. As shown in FIG. 1, the user interface may comprise a plurality of control switches 12, 13, 14 and 15 arranged to smoothly join the shape of the exterior of the helmet. In the particular example the controls are integrated with the chin guard 6 and the lower sides of the helmet.

A control apparatus for controlling audio features, such as communication interfaces, audio output and audio source, in response to the user input via the user interface and/or automatically in response to at least one predefined event is also integrated with the helmet. The predetermined event may comprise, for example, a change in the state of communications via the second communication interface, an incoming call, the end of a call, or start of a public announcement. The call can be a call via the second interface from another user in the group or a call via the external audio source provided with cellular phone capabilities and connected to a cellular system.

The control apparatus can be configured to determine the state of communications on the second communication interface and in response thereto apply a control operation on audio output generated based on a signal received via the first communication interface. Also, the state of communication on the first communication interface can be taken into account in determining appropriate control operation to be taken.

A control operation in response to detection of incoming and/or outgoing communications via the second communication interface can comprise, for example, cutting off or turning down volume of audio output generated based on a signal from the first communication interface or commanding the audio source to pause the playback. A control operation in response to detection of the end of communications via the second communication interface may comprise turning up volume of the audio output based on a signal from the first communication interface or commanding the audio source to return to the playback mode.

The control apparatus can determine the change in the state of the second communication interface based on various indications. For example, in case of push-to-talk type arrangements a push-to-talk button is used to enable the transmitter of the second communication interface for the duration that the button is held, and determination of this can automatically result in the control operation. On a receiving helmet a combination of carrier detection and tone/digital coded squelching (CTCSS/CDCSS) can be used as a basis to determine whether or not a valid incoming signal is being received via the second interface and therefore when to lower the volume of any audio output based on the first interface such that the received signal can be clearly relayed to the user.

The user interface can be used to control the two way communications for example to initiate and/or maintain a communications session and/or control the volume thereof. In addition to control of the two-way communications, the user control interface can also be configured to enable the user to perform control operations on the audio source. For example, the user interface can be configured to enable input of at least one of the following commands: on, off, play, pause, stop, forward, rewind, skip, answer a call, end a call, volume up, volume down, and mute,

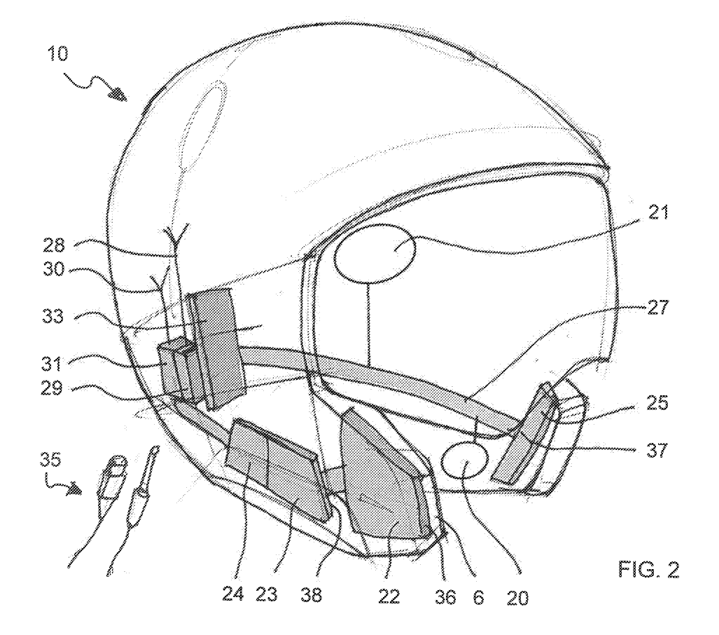

A more detailed example of the integration of the electronics is now described with reference to FIG. 2 showing the helmet 10 such that certain internal components are visible. The helmet is shown to be provided with a microphone 20 integrated with the chin guard 6 for enabling the user to input speech and thereby talk with other parties. An audio output device 21, for example an earpiece or headphone, is integrated with the padding of the helmet 10 to enable reproduction of audio for the user. In the example only one audio output device is shown but the number of audio outputs can depend on the application and can be higher, for example two, three or even more.

In FIG. 2 a radio unit 29 and an antenna 28 for providing the first communication interface are shown as being integrated with the helmet 10. The antenna 28 can be mounted such that it does not protrude from the exterior of the helmet. The components of the first communication interface can be capable of communication via a Bluetooth protocol connection. It is also possible that the built-in audio output devices can be Bluetooth capable speakers connected directly without a separate radio unit via a Bluetooth protocol connection to the external audio source worn by the user. It is noted that the communications can occur also via another short range radio communications link than Bluetooth.

Further, a second radio unit 31 and antenna 30 thereof are also provided. The second radio unit provides analogue two-way radio for communications on an unlicensed frequency band with other users. The antenna 30 is integrated with the helmet so that it does not extend from the outer shell.

Components of the audio system are connected by circuitry 27 within the helmet.

A user can control the operations of the audio apparatus of the helmet and/or the external audio source by means of control switches on the sides of the helmet 10. According to the example of FIGS. 1 and 2 the right-hand side of the chin guard 6 is provided with control 12. This can be arranged as a primary control of the external audio source. The control can be a multifunction switch, e.g., such that a single pressing of the switch results in play or pausing of an audio presentation by the external audio source, double pressing of the switch results in another operation such as fast forward, and holding the switch down for a predefined period would for example give a command to put an incoming call on hold or release the call. Other actions can be assigned for the control such as pairing with a Bluetooth device and so forth. Secondary controls 13 and 14 shown in the example can be, e.g., for controlling certain auxiliary functions of the audio source. For example, these controls can be for commanding volume up and down, to skip a track forward or back and so forth.

The left-hand side can have one or more controls 15 for controlling the two-way communications apparatus, for example for controlling initiation of communications via the two-way radio, volume thereof and so forth.

It shall be appreciated that the functions associated with the controls are only given herein as an example. An important feature is that the controls 12-15 are provided on the exterior of the helmet in a location where the controls can be easily reached and operated by the user. The controls are configured such that they join smoothly the overall appearance of the helmet and will not hinder the activities of the user. The user can easily reach and operate the controls without being unnecessarily distracted because of the location of the controls in known and easy-to-touch positions such as in the front portion of the chin guard. The ease of use and operability can be further enhanced by making the control switches, or at least the most frequently used switches, relatively large so that they can be touched when wearing gloves and/or with a rapid press or swipe in “about the right direction”.

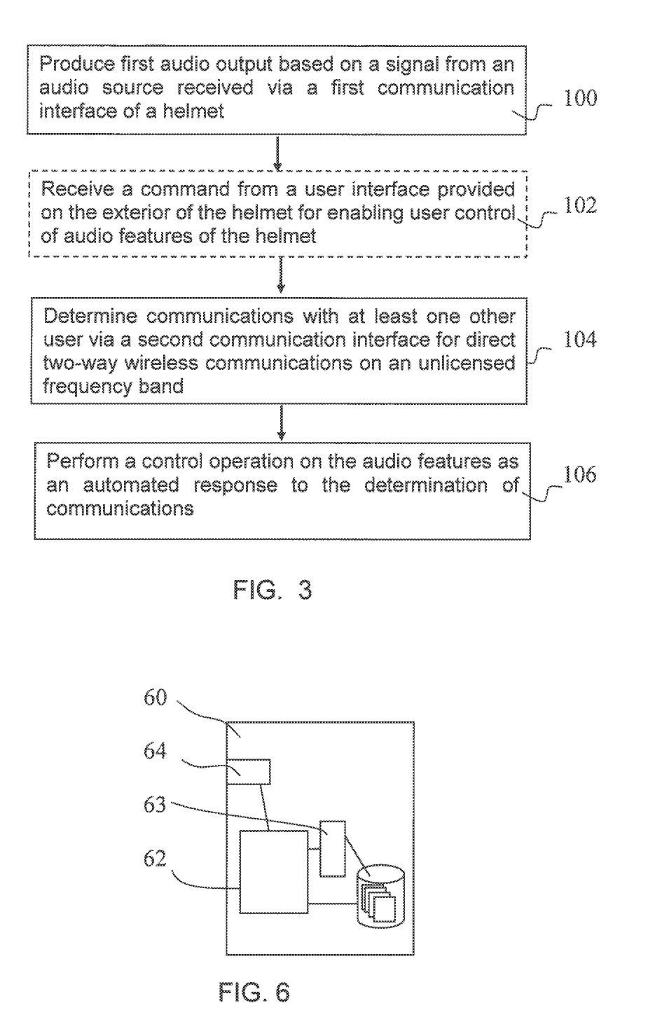

FIG. 3 illustrates a flowchart for a method for controlling audio features provided for a user of a helmet by an audio apparatus integrated with the helmet. In the method a first audio output is produced at 100 based on a signal received from an audio source via a first communication interface of the helmet.

The control apparatus of the helmet can receive a command input by the user via a user interface provided on the exterior of the helmet, thereby enabling the user to control at least some of the audio features. This step is not necessary in all circumstances to perform automated control of communications with other users, and therefore the block is drawn by a dashed line. It is also noted that the command can be e.g. start, play, return play or the like and thus a user command can be received before any audio output is produced. Therefore steps 100 and 102 can be in a different order from that shown, or take place in parallel.

The control apparatus can determine at 104 communications with at least one other user via a second communication interface, the second interface being for direct two-way wireless communications on an unlicensed frequency band. A control operation can be performed at 106 by the control apparatus of the helmet on the audio features as an automated response to the determination of the communications via the second communications interface.

The user can also input a command via the user interface at this stage. The arrangement can be such that the automated response takes precedence on, i.e. overrides, any commands, or at least some of the commands, via the user interface.

In accordance with an embodiment the control electronics determines active direct communications with at least one other user via an analogue interface. In response thereto a control operation is applied automatically on audio output generated based on a signal from the audio source. For example, the user may be listening to music from a music player and the control operation can comprise automatic cutting off or turning down the volume of the music in response to receiving a call. The automated control operation may also comprise, in response to detection of the end of communications via the analogue communication interface, turning up volume of audio output based on a signal from the first communication interface or issuing a command for the audio source to return to the playback mode.

The automated control of the audio output, e.g. from a music or other media player in response to determined communications on the two-way radio link, can be advantageous because the user is freed from the need to control manually the playback device, and can thus concentrate fully with both hands on the activity. Automated silencing of the music or other loud audio presentations can also be used to ensure that any important messages such as safety announcements and warnings are not missed by users listening to music or other loud audio.

A more detailed example of implementing the apparatus within the helmet is now described with reference again to FIG. 2. Both the right and left sides of the helmet can include printed circuit boards (PCBs) 36, 37 and 38. The PCBs can comprise, for example, switch contact points to interface with a moulded silicon rubber key pad or surface mount type (SMT) switch. In FIG. 2 PCB 38 is shown to provide switches 23 and 23, PCB 36 switch 22 and PCB 37 switch 25.

At least one of the PCBs, for example the left PCB 37, can incorporate a microcontroller for the purposes of performing audio processing and controlling overall audio output functionality of the helmet. One of the PCBs can further incorporate a programmable two-way analogue transceiver compatible with one or more licence-free public radio standards. A PCB can also incorporate microphone pre-amplifiers and analogue-to-digital convertors for the purpose of digitising audio pick-up by the microphone 20. Power amplifiers and digital-to-analogue convertors capable of driving the output devices can also be provided. An analogue-to-digital convertor for digitising audio received by the two-way analogue radio interface can also be provided as well as a digital-to-analogue convertor for converting digitised audio for transmission by the two-way analogue radio. Digital audio and control commands to and from the external audio source can also be processed by one of the printed circuit boards.

Settings and any configuration data can be stored in a non-volatile memory of a PCB. The data can be readable/writeable over a Bluetooth connection or otherwise.

Firmware and a short range radio module provided by a relevant PCB can be configured to support appropriate profiles and codecs to enable playback of music and other audio by the paired audio source device. The firmware and short range radio module can support profiles to enable participation in incoming calls received by the paired device using the hardware of the audio output system of the helmet. Transmission of status information and reception of configuration/firmware updates to/from the paired device can also be enabled.

In accordance with an example the control apparatus and a control switch can be configured to implement a push-to-talk function. A momentary button, referred to as the push-to-talk button, can be used to close relevant contacts when pressed and open the push-to-talk channel. When the push-to-talk button is not pressed and no incoming call is received by the two-way analogue radio, the firmware can control the operation such that audio is played by the external audio source and received via the first interface through left and right headphone drivers. The arrangement can be such that when the push-to-talk button is pressed, only tones from the second interface are audible through left and right headphone drivers and sound from microphone(s) is transmitted by the two-way radio. When the push-to-talk button is not pressed and an incoming call is received by the two-way analogue radio, firmware detects this and plays only audio received by the radio through left and right headphone drivers and a side-tone, while automatically silencing any sound from the external audio source.

It is also possible to have a call via the first interface and the external audio source. When a call over the first interface is in progress, the audio stream from one or more microphones is sent to the associated radio module. However, the configuration can be such that determination of communications via the second interface silences or puts on hold such a call via the first interface.

The firmware can also be configured for enabling/disabling the two-way analogue radio. When the two-way analogue radio is disabled, the state of the push-to-talk button can be ignored; it can be considered as if it is always open and no push-to-talk communications are taking place.

In accordance with an arrangement external connectors 35 can be plugged into the helmet through appropriate sockets. For example, the external connectors can be for charging a battery 33 of the helmet, connecting to the external audio source and/or to another data storage apparatus, etc.

In accordance with a possibility the helmet is provided with a wireless charging facility.

A user can assign an ID for his/her helmet. This ID can be displayed for example on a paired device on a display thereof. The ID can be stored and retrieved to/from a non-volatile memory of the helmet via the short range connection, such as Bluetooth.

Different geographical areas can have different frequency bands available for the unlicensed communications. For example, different countries have different restrictions on available frequencies. The radio unit can be configured to operate in different bands. In accordance with an embodiment, selection of an appropriate frequency band is automatic. The selection can be based on a positioning system. The frequency band can be selected based on information from a satellite based positioning system and/or a cellular network based positioning system. For example, Global Positioning System (GPS) can be used as the basis of the selection. The GPS capability can be provided by the external audio source, for example a smart phone. Another example is use of knowledge of the cell ID of the cellular system that is available at a device capable of communicating via the cellular system. Based on this information it is possible to determine the location and hence the available band(s).

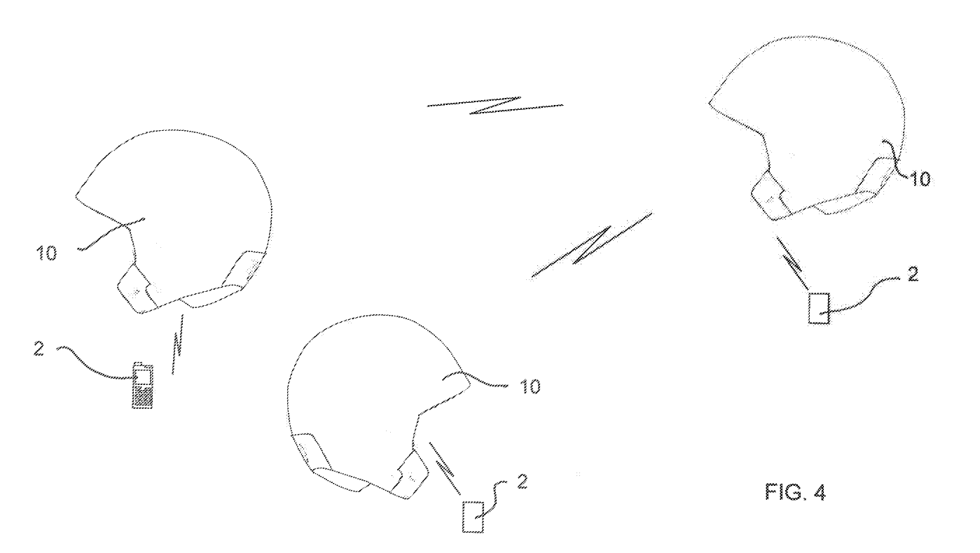

FIG. 4 shows an example of a use scenario where a group of users 1 communicate via their respective helmets 10 (only the helmets shown). The users each also carry with them at least one associated external audio source 2. At least one of the users can be further away and out of sight and/or separated by a distance or obstacle preventing use of a short range wireless technology for the communications. Further, at least one users can be located in an area with poor or non-existing cellular coverage.

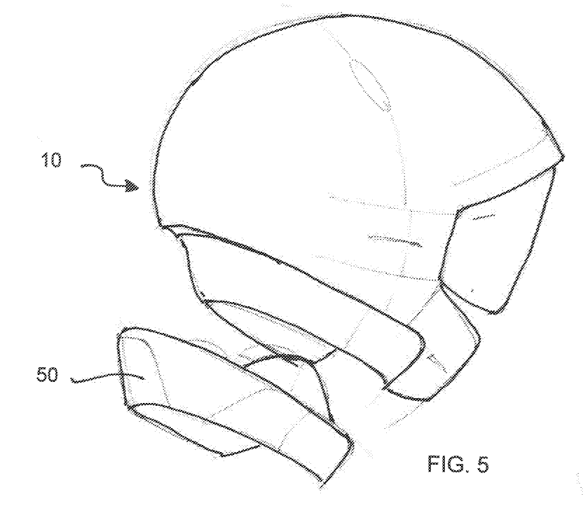

FIG. 5 shows an embodiment where a helmet 10 comprises a sub-assembly module 50 including control electronics. When assembled, the sub-assembly module 50 joins smoothly with the overall shape of the helmet 10.

FIG. 6 shows an example of control apparatus for a device capable of providing the above described functions of controlling the audio features of a helmet. The control apparatus 60 can be for example integrated with, coupled to and/or otherwise controlling any of integrated radio apparatus, audio output devices and microphones and/or external audio sources. For this purpose the control apparatus comprises at least one memory 61, at least one data processing unit 62, 63 and an input/output interface 64. Via the interface the control apparatus can be coupled to the internal communication circuitry of the helmet. The control apparatus can be configured to execute an appropriate software code to provide the control functions. The control apparatus can also be interconnected with other control entities. It is possible to have a multiple of processors providing the herein described functions.

Various embodiments and their combinations or subdivisions may be implemented as methods, apparatuses, or computer program products. Methods for downloading computer program code for performing the same may also be provided. Computer program products may be stored on non-transitory computer-readable media, such as memory chips, or memory blocks implemented within the processor, magnetic media such as hard disk or floppy disks, and optical media such as for example DVD and the data variants thereof, CD, magnetic disk, or semiconductor memory. Method steps may be implemented using instructions operable to cause a computer to perform the method steps using a processor and memory. The instructions may be stored on any computer-readable media, such as memory or non-volatile storage.

The data processors may be of any type suitable to the technical environment of the helmet, and may include one or more of general purpose computer chips, special purpose computer chips, microprocessors, digital signal processors (DSPs), application specific integrated circuits (ASIC), gate level circuits and processors based on multi core processor architecture, as non-limiting examples. The data processing may be distributed across several data processing modules. The memory or memories may be of any type suitable to the technical environment and may be implemented using any suitable data storage technology, such as semiconductor based memory devices, magnetic memory devices and systems, optical memory devices and systems, fixed memory and removable memory.

According to an embodiment there is provided a computer program comprising code means adapted to perform, when the program is run on processor apparatus, the above described methods.

While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The foregoing description provides by way of exemplary and non-limiting examples a full and informative description of exemplary embodiments of the invention. However, various modifications and adaptations may become apparent to those skilled in the relevant arts in view of the foregoing description, when read in conjunction with the accompanying drawings and the appended claims. All such and similar modifications of the teachings of this invention will still fall within the spirit and scope of this invention.

### APPENDIX

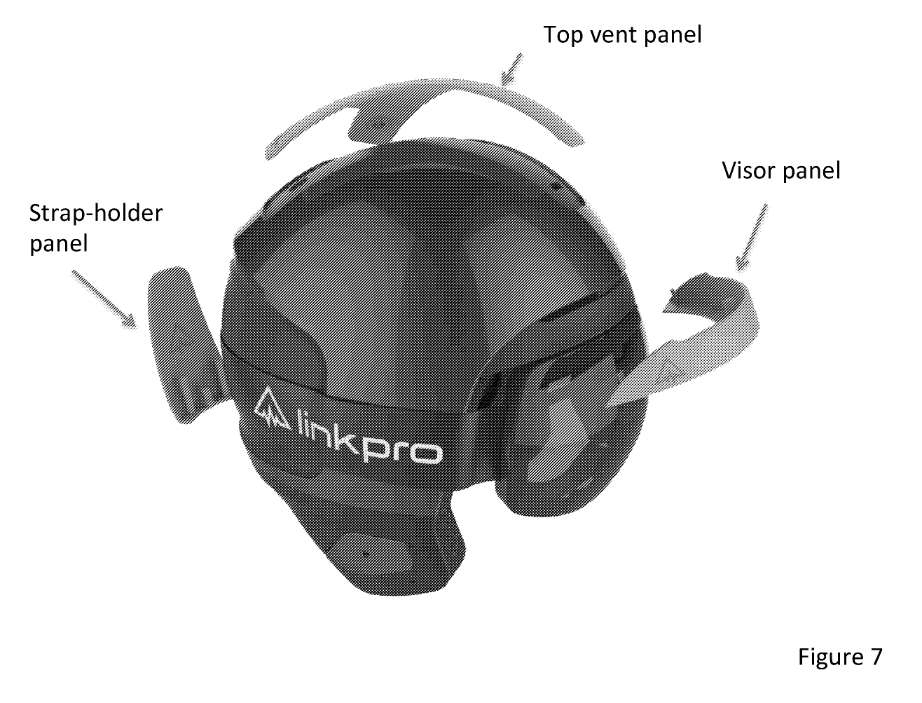

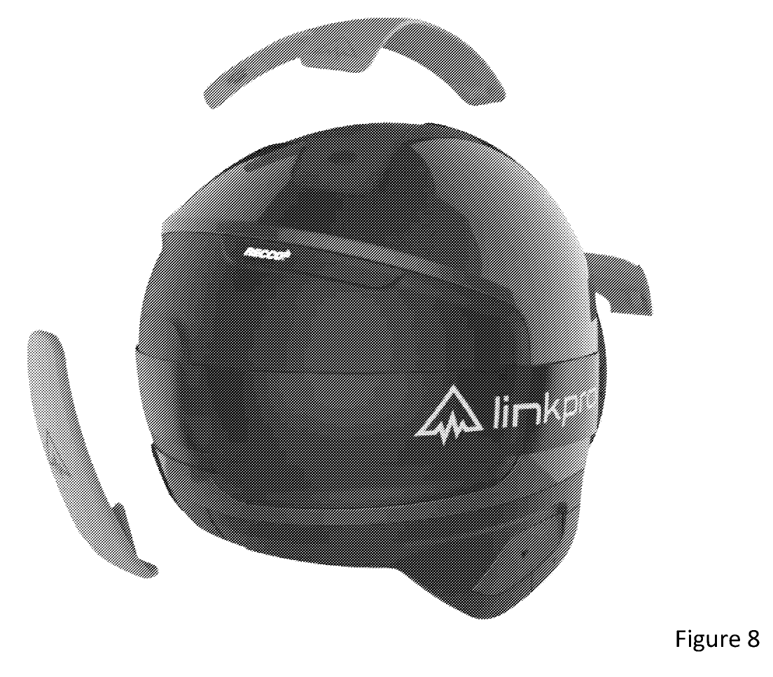

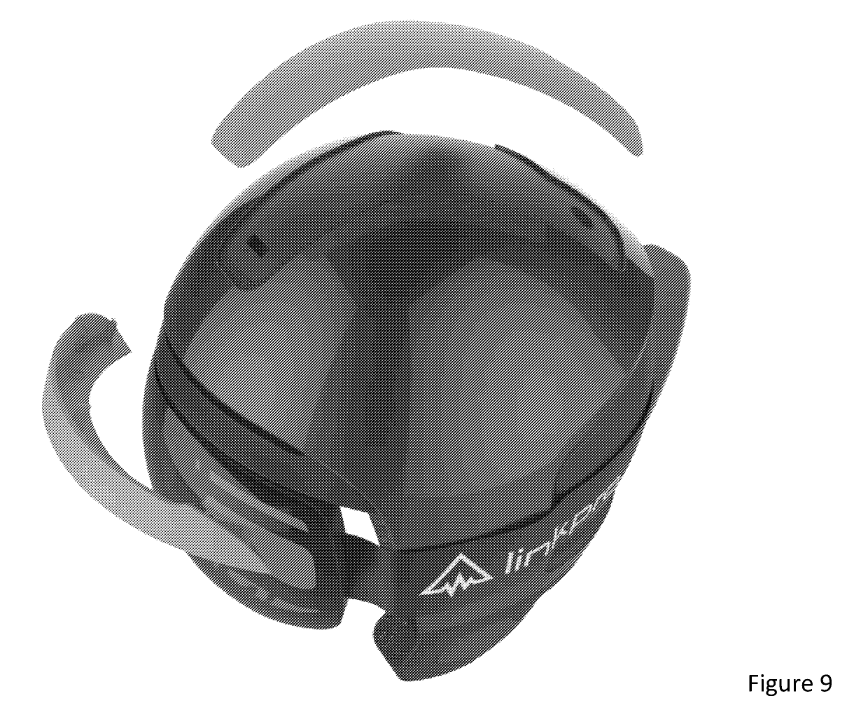

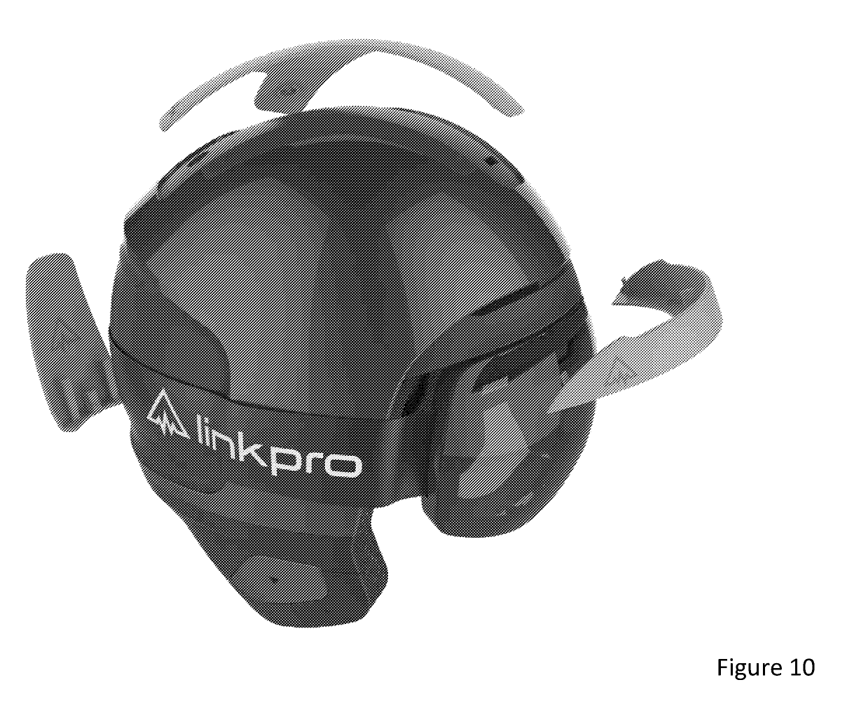

One feature of the helmet is that it includes removable panels, such as a visor or peak panel at the front of the helmet, a top ventilation panel and a strap holder panel at the back of the helmet. These are all readily removable from the helmet; they may be clip-fixed or magnetically attached in some other form of attachment. Because they are removable, they can be replaced with matching panels that perform different functions and/or are in different colours. FIGS. 7-10 are exploded views showing a helmet with each removable panel spaced apart from the helmet shell.

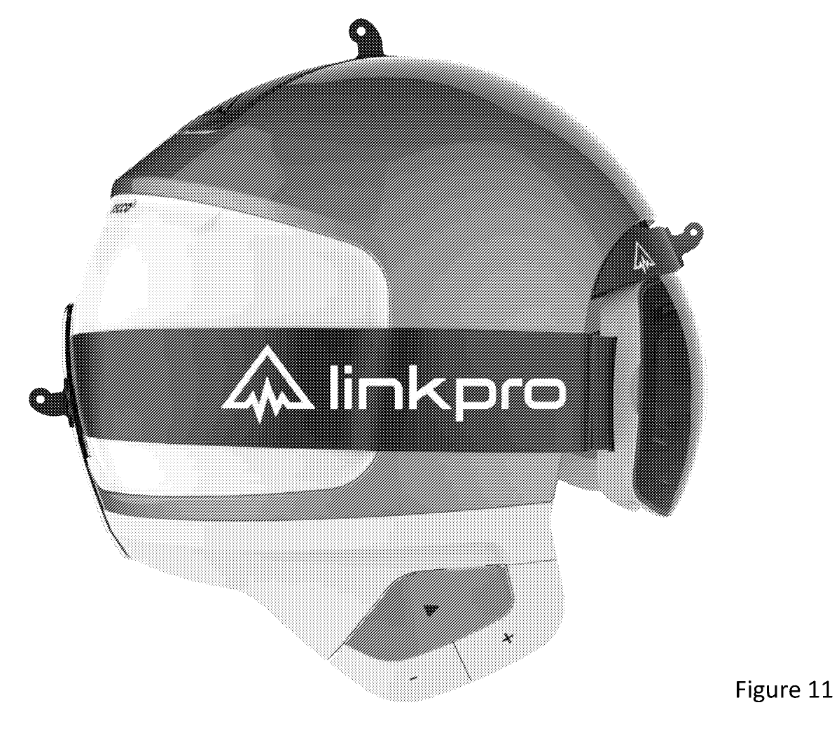

Any of the panels could be replaced with matching panels that include a small integrated mounting eye for an action camera: FIG. 11 shows this.

The top ventilation panel could be replaced with a panel with a different airhole arrangement—for example, when snowboarding in warm conditions, the top panel would be swapped out for a panel with much larger air ventilation holes, or even a light mesh.

Any of the replaceable panels could include integrated electronics, such as a barometer, accelerometer, IMU, cpu, processors, body sensors, shock sensors, GPS module, radios, short-range radio, 2-way communications radio, music player, signal reflector for detection in an avalanche, safety transponder, location transmitter etc.

Any of the replaceable panels could include an integrated video camera.

Any of the replaceable panels could include an integrated light source or flashlight; the flashlight can be readily removed for use.

Any of the replaceable panels could include cosmetic features—for instance, the peak panel could be a flat peak as shown, or could include a skip peak or other shape. Or they could include other decorative features or shapes.

The helmet can also work as a portable (e.g. Bluetooth) loudspeaker when not being worn and as headphones when being worn—e.g. can deliver high volume, instantaneous power output of 1 W+ or more from the helmet loudspeakers that are normally used as headphone speakers (drawing substantially less power, e.g. perhaps 10 mW max power). The helmet includes a safety sensor so that it cannot switch to loudspeaker mode when being worn. Electronic circuitry includes capacitor(s) that can store sufficient power needed to drive instantaneous high volumes, as needed for it the helmet to operate as a stand-alone speaker when not being worn on a user's head. The speakers that are integral to the helmet may swivel or alter their orientation, for example facing inwards towards the user's ears when in normal helmet headphones mode, and swiveling outwards when in loudspeaker mode.

The communications circuitry and antenna for the helmet (e.g. providing short-range Bluetooth as well as a radio transceiver) is in a detachable module that can attach to the helmet (e.g. the helmet casing or other parts of the helmet). This module can connect via short range wireless (e.g. Bluetooth LE) to the speaker circuitry in the helmet, so the module can be carried in a backpack etc for better protection. This makes the helmet itself a bit lighter and cheaper and the module can be sold as an after-market accessory. Also, different specifications of module (e.g. different ranges, numbers of channels, integral GPS etc) can be available so the customer chooses the one that best suits their needs and budget.

Voice encryption/scrambling is an option for compatible helmet to helmet communications (e.g. walkie-talkie communications between helmets that implement the full feature set of this invention). Radio communications to other users are not encrypted or otherwise scrambled, but in the clear. Encryption can be achieved by e.g. helmets sharing encryption keys at the start of any voice communications. This is more effective than conventional tone squelch CTCSS systems in providing privacy.

Normal walkie-talkies (e.g. FRS-US Family Radio Service) are analog (e.g. FM) and grab an entire channel for a single person who wants to speak and so are spectrally very inefficient. There are various initiatives to provide a digital equivalent to conventional, analog walkie-talkies, like D-STAR (packet-based, FDMA) and other digital two-way radios, like dPMR and eXRS (eXtreme Radio Service-frequency hopping spread spectrum). But analog can still have advantages in terms of cost, simplicity and range. The approach here is to retain an analog carrier, but to automatically grab a channel only for the short duration that speech is being transmitted; the channel is then automatically released once the speech ends. Speech is buffered for a short space of time and scheduled for transmission only once a channel is made available. This increases the number of helmet users that can communicate over the channel and reduces the awkward silences that accompany normal manual channel grabbing and ungrabbing.

The helmet is aware of (e.g. handles data that defines its location—e.g. through GPS module in the helmet or in a connected communications module) and can automatically generate location specific spoken messages played through the helmet speakers—e.g. current speed, name of piste or run, instructions to turn left or turn right at the next bend etc, like a GPS satellite navigation device's spoken instructions. Any music being played back through the helmet speakers is faded out whilst the message is being played. The helmet can also be aware of (e.g. receive data relevant to) the location of other helmets and their speed etc and can hence automatically generate specific spoken messages played through the helmet speakers, such as telling him if one member of the party is more than 250 m away from you or has stopped, if one member of your party is approaching you from behind at a faster speed etc., if one member of the party appears from an IMU inertial measurement unit in their helmet and also shared with others in his group to have had a significant impact and is no longer skiing etc. As before, any music being played back through the helmet speakers is faded out whilst the message is being played.

A final feature is the ability to have an open channel of communication whereby users can effectively talk over one another in normal conversation. i.e. you don't have to hold the push to talk button to communicate. This would be done by simply speaking into an open FM channel. This may be done via either FM or another short range mesh networking technology i.e. Bluetooth, WiFi etc.

Not that wherever we talk about spoken messages being played back through the helmet speakers, this could also be done (in addition or instead) through a head-up display or other display for the goggles worn by the skier.

1. A helmet configured to provide audio features for the user thereof, the helmet comprising:
a first communication interface for two-way wireless communications with an audio source, wherein a first audio output is generated based on signals received via the first communication interface,
a second communication interface for direct two-way wireless communications with at least one other user on an unlicensed frequency band, wherein a second audio output is generated based on signals received via the second communication interface,
at least one audio output device for audio output based on signals from the first and second communication interfaces,
a user interface for enabling the user to control the audio features of the helmet, and
control apparatus configured to control the audio features based on user input via the user interface and/or as an automated response to at least one predefined event.

2. A helmet according to claim 1, wherein the first communication interface comprises a short range wireless radio.

3. A helmet according to claim 2, wherein the short range wireless radio is configured to operate in accordance with the Bluetooth protocol.

4. A helmet according to claim 1, wherein the second communication interface comprises a radio unit configured for frequency modulated (FM) communications on ultrahigh frequency (UHF) or very high frequency (VHF) frequency bands.

5. (canceled)

6. A helmet according to claim, the user interface comprising switches arranged to smoothly join the shape of the exterior of the helmet.

7. A helmet according to claim 6, wherein at least one switch for controlling the first communication interface and/or the audio source is located on one side of the helmet and at least one switch for controlling the second communication interface is located on the other side of the helmet.

8. A helmet according to claim 1, wherein the predefined event comprises determination of at least one of a change in the state of communications via the second communication interface, an incoming call, end of a call, and a public announcement.

9. A helmet according to claim 1, wherein the control apparatus is configured to determine the state of communications on the second communication interface and in response to the determined state apply automatically a control operation on the first audio output.

10. A helmet according to claim 9, wherein the control operation comprises, in response to detection of initiation of communications via the second communication interface, cutting off or turning down volume of the first audio output or commanding pausing or stopping playback by the audio source.

11. A helmet according to claim 9, wherein the control operation comprises, in response to detection of end of communications via the second communication interface, turning up volume of the first audio output or commanding returning to playback mode of the audio source.

12. (canceled)

13. A helmet according to claim 1, wherein the user interface is configured to enable the user to perform a control operation on the audio source, wherein the user interface is configured to enable user to input at least one of the following commands: on, off, play, pause, stop, forward, rewind, skip, answer a call, end a call, volume up, volume down, and mute.

14. A helmet according to claim 1, where the audio features further comprise a microphone connected at least to the second communication interface.

15. A helmet according to claim 1, wherein the audio source comprises one of a mobile phone, a smart phone, a tablet computer, a notebook, a laptop computer, an electronic book, a music player and a recorder.

16. A helmet according to claim 1, wherein communications via the second communications interface comprise push-to-talk communications and the user interface comprises a push-to-talk switch.

17. A helmet according to claim 1, wherein the control apparatus is configured to automatically select a frequency band based on information of the location of the helmet.

18. (canceled)

19. A helmet according to claim 1, comprising a sub-assembly module including control electronics, the sub-assembly joining smoothly the overall shape of the helmet.

20. A helmet according to claim 1, that includes one or more removable panels, such as a visor or peak panel at the front of the helmet, a top ventilation panel and a strap holder panel at the back of the helmet.

21-25. (canceled)

26. The helmet of claim 20 in which one or more of the panels include a small integrated mounting eye for an action camera.

27. (canceled)

28. The helmet of claim 20 in which one or more of the replaceable panels includes integrated electronics, such as a barometer, accelerometer, IMU, cpu, GPS module, processors, body sensors, shock sensors, radios, short-range radio, 2-way communications radio, music player, signal reflector for detection in an avalanche, safety transponder, location transmitter.

29-38. (canceled)

39. The helmet of claim 1, including communications circuitry and antenna in a detachable module that is detachable from the helmet.

40. (canceled)

41. The helmet of claim 39 that is operable to connect via short range wireless to speaker circuitry in the helmet, so the module can be carried in a backpack etc for better protection.

42. The helmet of claim 1, including voice encryption apparatus or scrambling apparatus for compatible helmet to helmet communications.

43. The helmet of claim 42 operable to automatically grab a channel only for the short duration that speech is being transmitted; the channel is then automatically released once the speech end, and speech is buffered for a short space of time and scheduled for transmission only once a channel is made available.

44. The helmet of claim 1, in which the helmet handles data that defines its location and can automatically generate location specific spoken messages played through helmet speakers.

45. (canceled)

46. The helmet of claim 44 that includes a GPS module or receives data from a GPS module in a connected communications module.

47. The helmet of claim 44 that receives data relevant to the location of other helmets and/or their speed.

48. The helmet of claim 47 that automatically generates specific spoken messages played through the helmet speakers relevant to the location and/or speed and/or other events affecting users of other helmets.

49. The helmet of claim 1, including an open channel of communication whereby users can effectively talk over one another in normal conversation, such as an open FM channel or another short range mesh networking technology.

50. A communication system comprising at least two helmets and associated at least two audio sources, each helmet configured to provide audio features for the user thereof, each helmet comprising:
a first communication interface for two-way wireless communications with an audio source, wherein a first audio output is generated based on signals received via the first communication interface,
a second communication interface for direct two-way wireless communications with at least one other user on an unlicensed frequency band, wherein a second audio output is generated based on signals received via the second communication interface,
at least one audio output device for audio output based on signals from the first and second communication interfaces,
a user interface for enabling the user to control the audio features of the helmet, and
control apparatus configured to control the audio features based on user input via the user interface and/or as an automated response to at least one predefined event.

51. A method for controlling audio features provided for a user by an audio apparatus integrated with a helmet, the helmet comprising control apparatus responsive to user input via a user interface provided on the exterior of the helmet for enabling the user to control the audio features, the method comprising:
producing a first audio output based on a signal received from an audio source via a first communication interface for two-way wireless communications of the helmet,
determining by the control apparatus communications with at least one other user via a second communication interface for direct two-way wireless communications on an unlicensed frequency band, and
performing a control operation by the control apparatus of the helmet on the audio features as an automated response to the determination of the communications via the second communication interface.

52-59. (canceled)
